(19) United States
(12) Patent Application Publication
(10) Pub. No.: US 2024/0022579 A1
(43) Pub. Date: Jan. 18, 2024

(54) SYSTEM TO TERMINATE MALICIOUS PROCESS IN A DATA CENTER

(71) Applicant: VMWARE, INC., Palo Alto, CA (US)

(72) Inventor: MANISHA SAMEER GAMBHIR PAREKH, Pune (IN)

(21) Appl. No.: 17/958,538

(22) Filed: Oct. 3, 2022

(30) Foreign Application Priority Data
Jul. 16, 2022 (IN) 202241040756

(51) Int. Cl. H04L 9/40; G06F 9/455

(52) U.S. Cl. CPC H04L 63/1416; H04L 63/145; G06F 9/45558; G06F 2009/45587

(57) ABSTRACT

Example methods and systems for malicious process termination are described. In one example, a computer system may detect a first instance of a malicious network activity associated with a first virtualized computing instance. Termination of a first process implemented by the first virtualized computing instance may be triggered, the first instance of the malicious network activity being associated with the first process. The computer system may obtain event information associated with the first process and/or the first instance of the malicious network activity, and trigger termination of a second process implemented by a second virtualized computing instance based on the event information. Examples of the present disclosure may be implemented to leverage the detection of the first instance of the malicious network activity to terminate both the first process and the second process, and to block a second instance of a malicious network activity associated with the second process.

### RELATED APPLICATIONS

Benefit is claimed under 35 U.S.C. 119(a)-(d) to Foreign Application Serial No. 202241040756 filed in India entitled “SYSTEM TO TERMINATE MALICIOUS PROCESS IN A DATA CENTER”, on Jul. 16, 2022, by VMware, Inc., which is herein incorporated in its entirety by reference for all purposes.

### BACKGROUND

Virtualization allows the abstraction and pooling of hardware resources to support virtual machines in a software-defined data center (SDDC). For example, through server virtualization, virtualized computing instances such as virtual machines (VMs) running different operating systems may be supported by the same physical machine (e.g., host). Each VM is generally provisioned with virtual resources to run a guest operating system and applications. The virtual resources may include central processing unit (CPU) resources, memory resources, storage resources, network resources, etc. In practice, it is desirable to detect potential security threats that may affect the performance of hosts and VMs in the SDDC.

### BRIEF DESCRIPTION OF DRAWINGS

FIG. 1 is a schematic diagram illustrating an example software-defined networking (SDN) environment in which malicious process termination may be performed;

FIG. 2 is a schematic diagram illustrating an example physical view of hosts in an SDN environment;

FIG. 3 is a flowchart of an example process for a computer system to perform malicious process termination;

FIG. 4 is a flowchart of an example detailed process for a computer system to perform malicious process termination;

FIG. 5 is a schematic diagram illustrating a first example of malicious process termination in an SDN environment;

FIG. 6 is a schematic diagram illustrating a second example of malicious process termination in an SDN environment; and

FIG. 7 is a schematic diagram illustrating an example architecture for malware prevention in an SDN environment.

### DETAILED DESCRIPTION

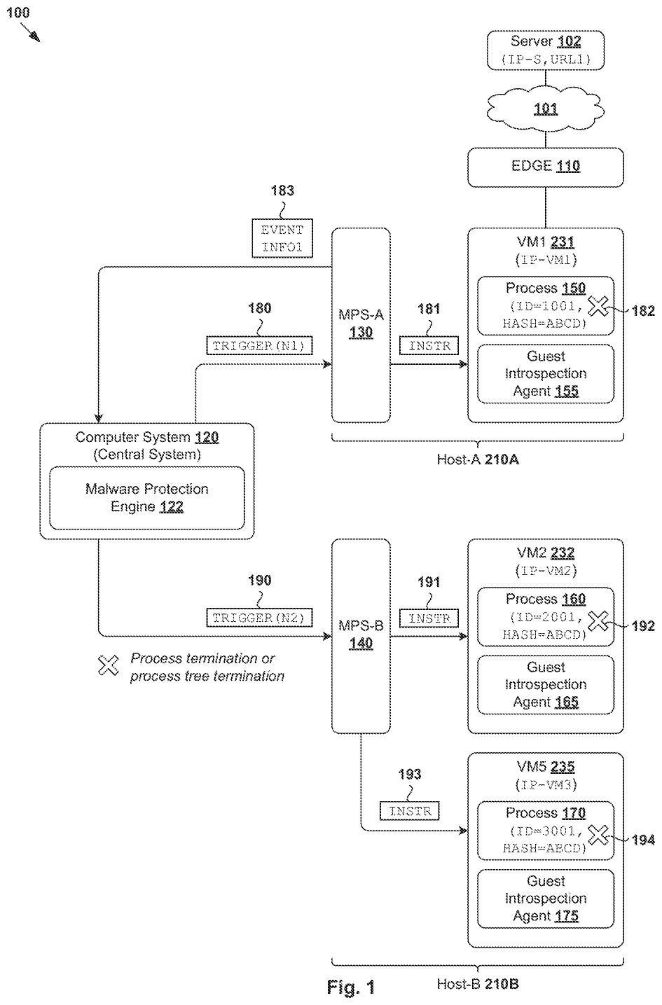

According to examples of the present disclosure, malicious process termination may be implemented to improve data center security. One example may involve a computer system (e.g., 120 in FIG. 1) detecting a first instance of a malicious network activity associated with a first virtualized computing instance (e.g., VM1 231 in FIG. 1), and triggering termination of a first process implemented by the first virtualized computing instance (e.g., 150 in FIG. 1). The computer system may obtain event information associated with the first process and/or the first instance of the malicious network activity, and trigger termination of a second process (e.g., 160 in FIG. 1) implemented by a second virtualized computing instance (e.g., VM2 232 in FIG. 1) based on the event information. Examples of the present disclosure may be implemented to leverage the detection of the first instance of the malicious network activity to terminate both the first process and the second process. Any existing or potential second instance of the malicious network activity associated with second process 160 may also be blocked. Various examples will be discussed using FIGS. 1-7.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein. Although the terms “first” and “second” are used to describe various elements, these elements should not be limited by these terms. These terms are used to distinguish one element from another. For example, a first element may be referred to as a second element, and vice versa.

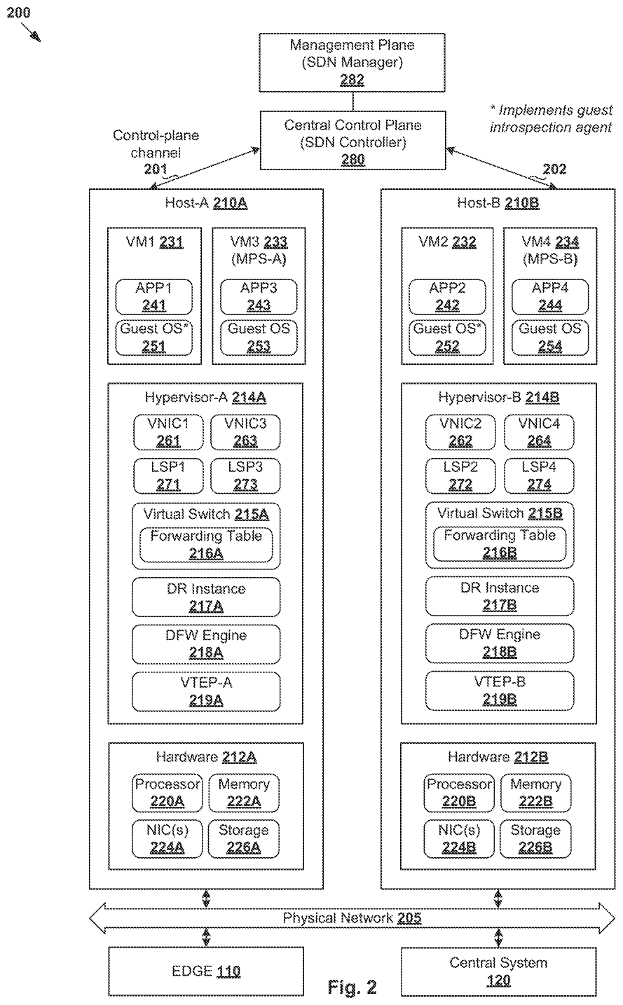

FIG. 1 is a schematic diagram illustrating example software-defined networking (SDN) environment 100 in which identity firewall with context information tracking may be performed. FIG. 2 is a schematic diagram illustrating example physical view 200 of hosts in SDN environment 100. It should be understood that, depending on the desired implementation, SDN environment 100 may include additional and/or alternative components than that shown in FIG. 1 and FIG. 2. In practice, SDN environment 100 may include any number of hosts (also known as “computer systems,” “computing devices”, “host computers”, “host devices”, “physical servers”, “server systems”, “transport nodes,” etc.).

In the example in FIG. 1, software-defined data center (SDDC) or SDN environment 100 may include EDGE 110 that is deployed at the edge of a data center to provide networking services to various hosts, such as host-A 210A and host-B 210B. Example services may include one or more of the following: gateway service (e.g., tier-0 gateway service), virtual private network (VPN) service, firewall service, domain name system (DNS) forwarding, IP address assignment using dynamic host configuration protocol (DHCP), source network address translation (SNAT), destination NAT (DNAT), deep packet inspection, etc.

In practice, an EDGE node may be an entity that is implemented using one or more virtual machines (VMs) and/or physical machines (known as “bare metal machines”) and capable of performing functionalities of a switch, router, bridge, gateway, edge appliance, or any combination thereof. EDGE 110 may be deployed to facilitate north-south traffic forwarding, such as between a VM supported by host 210A/210B and a remote destination that is located at a different geographical site. For example, packets belonging to a packet flow between VM1 231 on host-A 210A and remote server 102 that is reachable via layer-3 network 101 (e.g., Internet) may be forwarded via EDGE 110.

Referring also to FIG. 2, host 210A/210B may include suitable hardware 212A/212B and virtualization software (e.g., hypervisor-A 214A, hypervisor-B 214B) to support various VMs. For example, host-A 210A may support VM1 231 and VM3 233, while host-B 210B may support VM2 232, VM4 234 and VM5 235 (not shown in FIG. 2 for simplicity). Hardware 212A/212B includes suitable physical components, such as central processing unit(s) (CPU(s)) or processor(s) 220A/220B; memory 222A/222B; physical network interface controllers (PNICs) 224A/224B; and storage disk(s) 226A/226B, etc.

Hypervisor 214A/214B maintains a mapping between underlying hardware 212A/212B and virtual resources allocated to respective VMs. Virtual resources are allocated to respective VMs 231-234 to each support a guest operating system (OS) and application(s); see 241-244, 251-254. For example, the virtual resources may include virtual CPU, guest physical memory, virtual disk, virtual network interface controller (VNIC), etc. Hardware resources may be emulated using virtual machine monitors (VMMs). For example in FIG. 2, VNICs 261-264 are virtual network adapters for VMs 231-234, respectively, and are emulated by corresponding VMMs (not shown) instantiated by their respective hypervisor at respective host-A 210A and host-B 210B. The VMMs may be considered as part of respective VMs, or alternatively, separated from the VMs. Although one-to-one relationships are shown, one VM may be associated with multiple VNICs (each VNIC having its own network address).

Although examples of the present disclosure refer to VMs, it should be understood that a “virtual machine” running on a host is merely one example of a “virtualized computing instance” or “workload.” A virtualized computing instance may represent an addressable data compute node (DCN) or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The VMs may also be complete computational environments, containing virtual equivalents of the hardware and software components of a physical computing system.

The term “hypervisor” may refer generally to a software layer or component that supports the execution of multiple virtualized computing instances, including system-level software in guest VMs that supports namespace containers such as Docker, etc. Hypervisors 214A-B may each implement any suitable virtualization technology, such as VMware ESX® or ESXi™ (available from VMware, Inc.), Kernel-based Virtual Machine (KVM), etc. The term “packet” may refer generally to a group of bits that can be transported together, and may be in another form, such as “frame,” “message,” “segment,” etc. The term “traffic” or “flow” may refer generally to multiple packets. The term “layer-2” may refer generally to a link layer or media access control (MAC) layer; “layer-3” a network or Internet Protocol (IP) layer; and “layer-4” a transport layer (e.g., using Transmission Control Protocol (TCP), User Datagram Protocol (UDP), etc.), in the Open System Interconnection (OSI) model, although the concepts described herein may be used with other networking models.

SDN controller 280 and SDN manager 282 are example network management entities in SDN environment 100. One example of an SDN controller is the NSX controller component of VMware NSX® (available from VMware, Inc.) that operates on a central control plane. SDN controller 280 may be a member of a controller cluster (not shown for simplicity) that is configurable using SDN manager 282. Network management entity 280/282 may be implemented using physical machine(s), VM(s), or both. To send or receive control information, a local control plane (LCP) agent (not shown) on host 210A/210B may interact with SDN controller 280 via control-plane channel 201/202.

Through virtualization of networking services in SDN environment 100, logical networks (also referred to as overlay networks or logical overlay networks) may be provisioned, changed, stored, deleted and restored programmatically without having to reconfigure the underlying physical hardware architecture. Hypervisor 214A/214B implements virtual switch 215A/215B and logical distributed router (DR) instance 217A/217B to handle egress packets from, and ingress packets to, VMs 231-234. In SDN environment 100, logical switches and logical DRs may be implemented in a distributed manner and can span multiple hosts.

For example, a logical switch (LS) may be deployed to provide logical layer-2 connectivity (i.e., an overlay network) to VMs 231-234. A logical switch may be implemented collectively by virtual switches 215A-B and represented internally using forwarding tables 216A-B at respective virtual switches 215A-B. Forwarding tables 216A-B may each include entries that collectively implement the respective logical switches. Further, logical DRs that provide logical layer-3 connectivity may be implemented collectively by DR instances 217A-B and represented internally using routing tables (not shown) at respective DR instances 217A-B. Each routing table may include entries that collectively implement the respective logical DRs.

Packets may be received from, or sent to, each VM via an associated logical port. For example, logical switch ports 271-274 (labelled “LSP1” to “LSP4”) are associated with respective VMs 231-234. Here, the term “logical port” or “logical switch port” may refer generally to a port on a logical switch to which a virtualized computing instance is connected. A “logical switch” may refer generally to a software-defined networking (SDN) construct that is collectively implemented by virtual switches 215A-B, whereas a “virtual switch” may refer generally to a software switch or software implementation of a physical switch. In practice, there is usually a one-to-one mapping between a logical port on a logical switch and a virtual port on virtual switch 215A/215B. However, the mapping may change in some scenarios, such as when the logical port is mapped to a different virtual port on a different virtual switch after migration of the corresponding virtualized computing instance (e.g., when the source host and destination host do not have a distributed virtual switch spanning them).

A logical overlay network may be formed using any suitable tunneling protocol, such as Virtual eXtensible Local Area Network (VXLAN), Stateless Transport Tunneling (STT), Generic Network Virtualization Encapsulation (GENEVE), Generic Routing Encapsulation (GRE), etc. For example, VXLAN is a layer-2 overlay scheme on a layer-3 network that uses tunnel encapsulation to extend layer-2 segments across multiple hosts which may reside on different layer 2 physical networks. Hypervisor 214A/214B may implement virtual tunnel endpoint (VTEP) 219A/219B to encapsulate and decapsulate packets with an outer header (also known as a tunnel header) identifying the relevant logical overlay network (e.g., VNI). Hosts 210A-B may maintain data-plane connectivity with each other via physical network 205 to facilitate east-west communication among VMs 231-234. Hosts 210A-B may also maintain data-plane connectivity with EDGE 110 via physical network 205 to facilitate north-south traffic forwarding.

### Data Center Security

One of the challenges in SDN environment 100 is improving the overall data center security. For example, to protect against security threats caused by unwanted packets, hypervisor 214A/214B may implement distributed firewall (DFW) engine 218A/218B to filter packets. For example, at host-A 210A, hypervisor 214A implements DFW engine 218A to filter packets for VM1 231. At host-A 210B, hypervisor 214B implements DFW engine 218B to filter packets for VM2 232. In practice, packets may be filtered at any point along the datapath from a source (e.g., VM1 231) to a physical NIC (e.g., 224A). In one embodiment, a filter component (not shown) may be incorporated into each of VNICs 241-244.

Further, EDGE 110 may be configured to detect potential security threats during north-south traffic forwarding between a VM (e.g., VM1 231) and remote server 102 reachable via Internet 101. For example in FIG. 1, first process 150 running on VM1 231 may be malware-infected and attempt to download malicious file(s) from a non-reputable website supported by remote server 102. The file download may be part of a security attack against host-A 210A and/or other entities in SDN environment 100.

Conventionally, when a connection or file download is suspected to be malicious, EDGE 110 may block the connection and stop the file download by resetting the connection. However, first process 150 may continue with its malicious network activity by, for example, initiating another connection to reattempt to file download. Further, second process 150 on VM2 133 and third process 170 on VM5 235 may also be malware-infected and attempt to download malicious file(s) from the same website. In this case, EDGE 110 has to repeat the process of detecting and blocking such malicious file downloads, thereby consuming precious processing resources.

### Malicious Process Termination

According to examples of the present disclosure, malicious process termination may be implemented to improve data center security. For example in FIG. 1, the detection of a first instance of a malicious network activity may be leveraged to terminate multiple processes, such as first process 150 on VM1 231, second process 160 on VM2 232 and/or third process 170 on VM5 235. Any potential or existing further instance of the malicious network activity may also be blocked. Examples of the present disclosure may also be implemented to ease processing burden associated with malware detection and/or prevention at various entities of the SDN environment 100, such as EDGE 110, etc.

As used herein, the term “process” may refer generally to an instance of a computing program (e.g., include executable code, machine instructions, variables, data, state information or any combination thereof, etc.) residing and/or operating in a kernel space, user space and/or other space of an operating system and/or computing environment. The term “security threat” or “malware” may be used as an umbrella term to cover hostile or intrusive software, including but not limited to botnets, viruses, worms, Trojan horse programs, spyware, phishing, adware, riskware, rootkits, spams, scareware, ransomware, or any combination thereof.

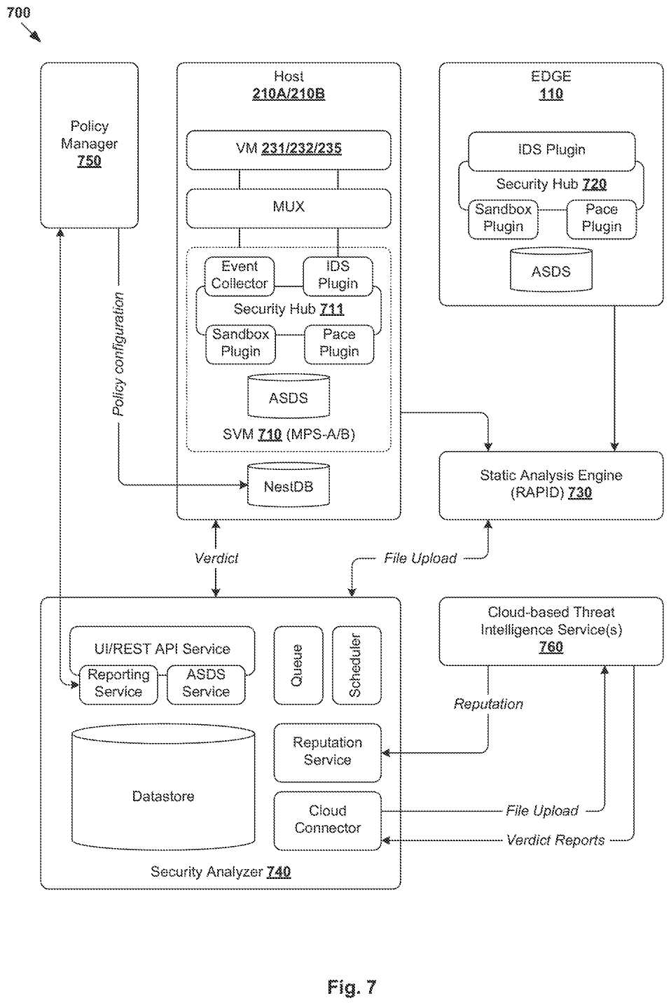

In the example in FIG. 1, computer system 120 (also known as central system) and multiple malware protection service (MPS) instances may be deployed to implement examples of the present disclosure. For example, host-A 210A may implement a first MPS instance (denoted as MPS-A 130) to provide malware protection for VM1 231. Host-B 210B may implement second MPS instance (denoted as MPS-B 140) to provide malware protection for VM2 232 and VM5 235. In practice, computer system 120, MPS instance 130/140 may be implemented using any physical machine(s) and/or virtualized computing instance(s). For example in FIG. 2, MPS-A 130 and MPS-B 140 may be in the form of service VMs (SVMs) implemented by hosts 210A-B respectively. Central system 120 may include malware protection engine 122 to implement examples of the present disclosure. Malware protection engine 122 may be configured to manage multiple MPS instances in SDN environment 100, including but not limited to MPS-A 130 and MPS-B 140. As will be described further using FIG. 7, malware protection engine 122 may include component(s) forming part of a malware protection system.

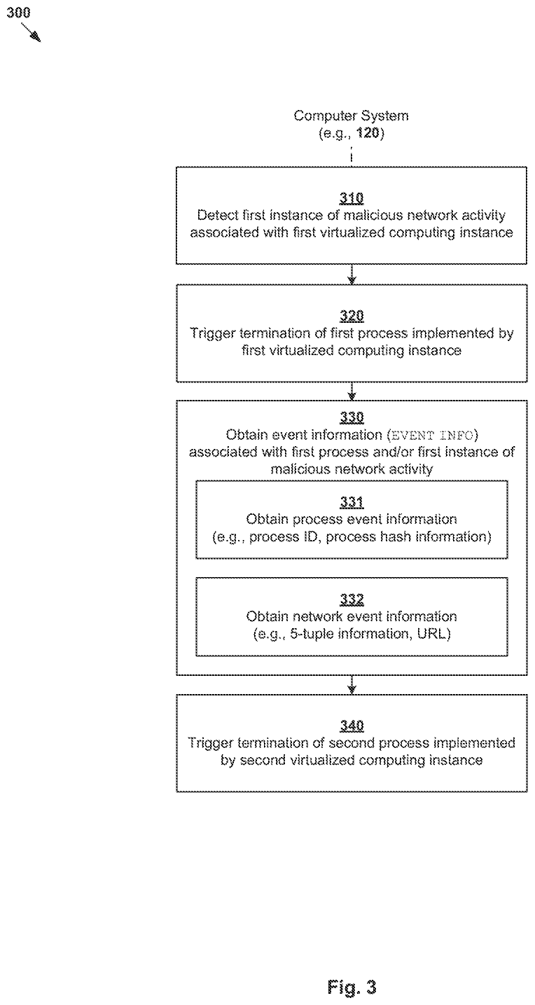

Some examples will be described using FIG. 3, which is a flowchart of example process 300 for a computer system to perform malicious process termination. Example process 300 may include one or more operations, functions, or actions illustrated by one or more blocks, such as 310 to 360. Depending on the desired implementation, various blocks may be combined into fewer blocks, divided into additional blocks, and/or eliminated. In the following, various examples will be described using central system 120 as an example “computer system,” VM1 231 as an example “first virtualized computing instance,” VM 232/235 as an example “second virtualized computing instance,” etc. In practice, any suitable “computer system” (i.e., not limited to central system 120) capable of triggering process termination according to examples of the present disclosure may be deployed.

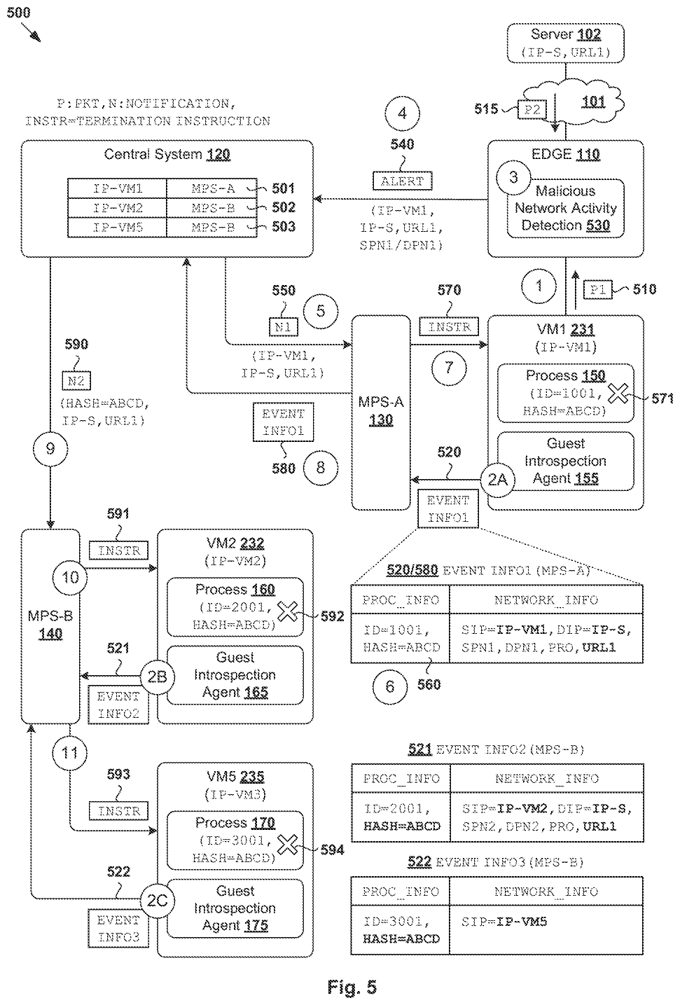

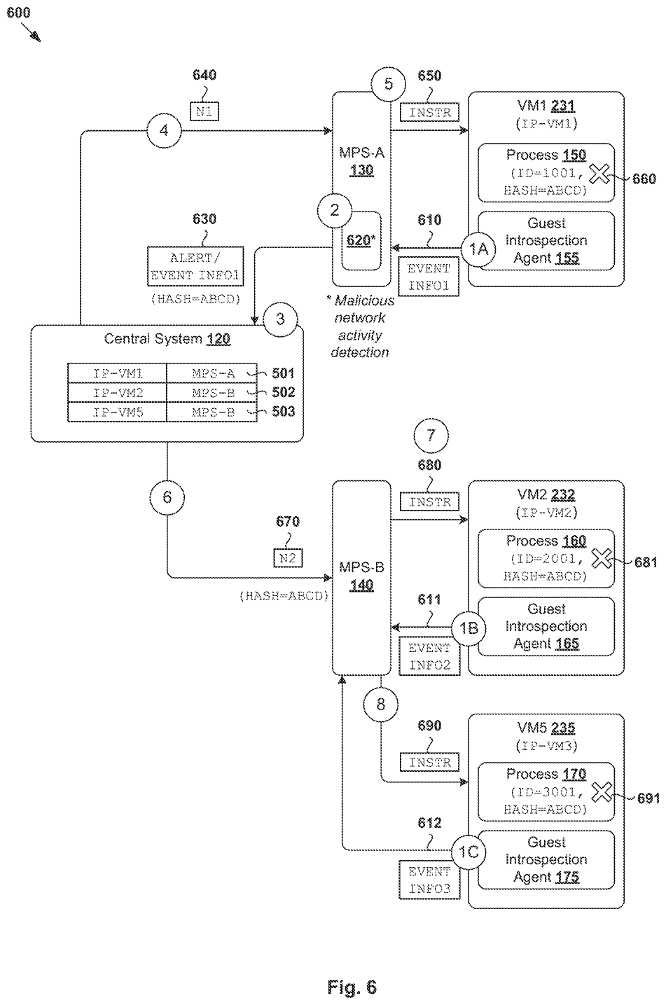

At 310-320 in FIG. 3, computer system 120 may detect a first instance of a malicious network activity associated with VM1 231, and trigger termination of first process 150 implemented by VM1 231. The first instance of a malicious network activity associated with first process 150 may be file download from remote server 102, file copy (e.g., from a universal serial bus (USB) drive or source on the network), etc. The detection at block 310 may be based on an alert received from any suitable entity capable of detecting the first instance of malicious network activity, such as EDGE 110 (to be described using FIG. 5), an MPS instance such as MPS-A 130 on host-A 210A (e.g., to be described using FIG. 6), deep packet inspection (DPI) entity, firewall, etc. See 180-182 in FIG. 1.

At 330 in FIG. 3, computer system 120 may obtain event information associated with first process 150 and/or the first instance of the malicious network activity. Here, the term “obtain” may refer generally to computer system 120 receiving or retrieving the information from a source or datastore. In the example in FIG. 1, the event information may be collected or generated by guest introspection agent 155, which is a thin agent implemented by guest OS 251 on VM1 231. In this case, the event information may be obtained by computer system 120 from MPS-A 130 configured to provide malware protection for VM1 231. See 183 in FIG. 1.

Depending on the desired implementation, the event information at block 330 may include process event information associated with first process 150 and/or network event information associated with the first instance of malicious network activity. The process event information associated with first process 150 may include process identifier (e.g., ID=1001), process hash information (e.g., HASH=ABCD), file name, license and certificate information, or any combination thereof, etc. The network event information may include 5-tuple information associated with a connection involving first process 150, a uniform resource locator (URL) from which file(s) may be downloaded, any combination thereof, etc. As will be exemplified using FIG. 5, computer system 120 may obtain 5-tuple information from EDGE 110, as well as destination address (i.e., remote IP address), source/destination port information (i.e., local and remote port numbers) from MPS-A 130. Any alternative and/or additional source(s) may be used in practice.

At 340 in FIG. 3, computer system 120 may trigger termination of second process 160 implemented by VM2 232 based on the event information. This way, examples of the present disclosure may be implemented to leverage the detection of the first instance of the malicious network activity to terminate both first process 150 and second process 160. Any existing or potential second instance of the malicious network activity associated with second process 160 may also be blocked. In the example in FIG. 1, computer system 120 may also trigger termination of third process 170 implemented by VM5 235 based on the event information to block a potential third instance of the malicious network activity. See 190-194 in FIG. 1.

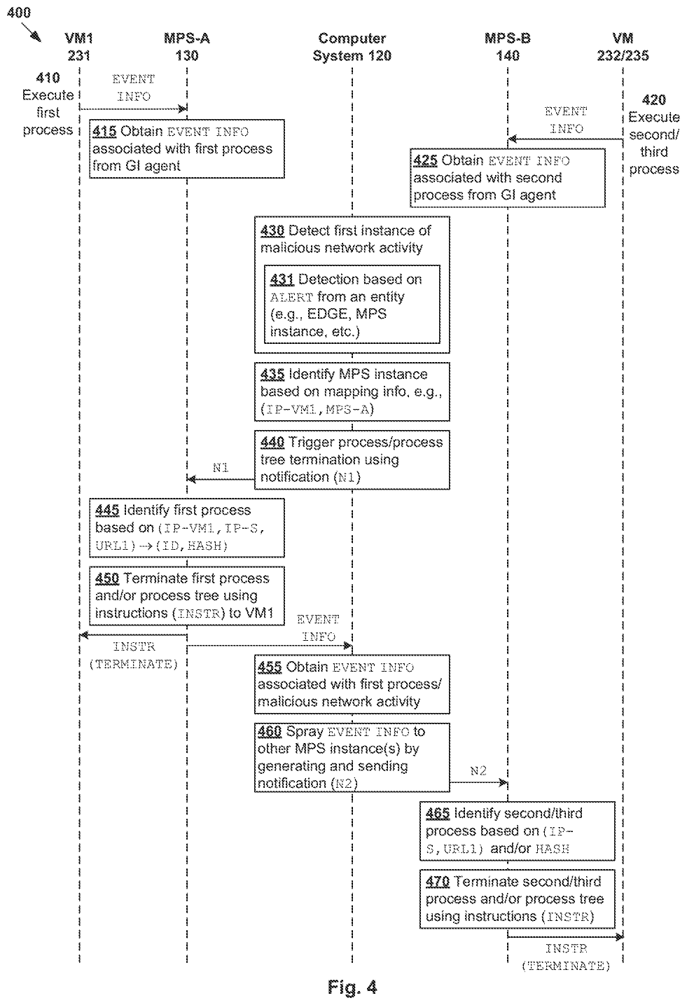

As will be exemplified using FIGS. 4-6, computer system 120 may trigger termination of other process(es) by disseminating or spraying the event information by generating and sending a second notification to at least one second MPS instance, including but not limited to MPS-B 140 in the example in FIG. 1. Note that process 160/170 may be implemented by VM 232/235 (a) at the time the event information is disseminated or (b) after the event information is disseminated (i.e., in the future). Similarly, the second instance of malicious activity may be initiated (a) before, (b) at the time or (c) after the event information is disseminated. Using examples of the present disclosure, the event information is disseminated to trigger termination of current and/or future process(es).

Examples of the present disclosure should be contrasted against conventional approaches that simply reset a connection when, for example, a malicious file download activity is detected. In contrast, using examples of the present disclosure, multiple processes may be terminated when a first instance of a malicious network activity is detected. In the case of north-south forwarding, examples of the present disclosure may reduce the processing burden at EDGE 110 to filter packets to/from malware-infected processes. Examples of the present disclosure may be implemented to facilitate at least one of the following to further strengthen data center security: endpoint detection and response (EDR), network detection and response (NDR) and extended detection and response (XDR). Various examples will be discussed below using FIGS. 4-7.

### First Example: Edge-Triggered Implementation

FIG. 4 is a flowchart of example detailed process 400 for a computer system to perform malicious process termination in an SDN environment. Example process 400 may include one or more operations, functions, or actions illustrated by one or more blocks, such as 410 to 470. Depending on the desired implementation, various blocks may be combined into fewer blocks, divided into additional blocks, and/or eliminated. Central system 120 may implement example process 400 using any suitable component(s), such as malware protection engine 122. The following notations will be used below: SIP=source IP address, DIP=destination IP address, SPN=source port number, DPN=destination port number and PRO=protocol, etc.

Some examples relating to an EDGE-triggered implementation for north-south traffic will be described using FIG. 5, which is a schematic diagram illustrating first example 500 of malicious process termination in an SDN environment. In the example in FIG. 5, VM1 231 may execute first process 150, VM2 232 second process 160 and VM5 235 third process 170. Each VM 231/232/235 may implement guest introspection agent 155/165/175 (e.g., on guest OS) that is configured to generate event information associated with process 150/160/170 and/or its network activity, such as establishing a connection with another server (e.g., remote server 102, another VM, etc.), sending packet(s) to and/or receiving packet(s) from that server, accessing resource(s), etc. See also 410 and 420 in FIG. 4.

(a) Event information

Referring to FIG. 5, at 510, first process 150 implemented by (i.e., running on) VM1 231 may initiate a network activity by generating and sending a first packet (P1) towards remote server 102 via EDGE 110, such as to perform a file download, etc. In response to P1 510, remote server 102 may generate and send a second packet (P2) 515 that includes the file requested (or portion thereof) towards VM1 231 via EDGE 110. Here, the term “file” may refer generally to any unit of computer-readable data that is downloadable from a source over a network. Examples may include executable file (e.g., computer-readable instructions or program code), data file (e.g., word document), audio file, video file, script, data object, image(s), package(s), library file, etc. In some cases, the file may be downloadable or readable in memory, which is usually more difficult to trace.

In practice, a file download may be performed using any suitable protocol, such as hypertext transfer protocol (HTTP), file transfer protocol (FTP), etc. For example, remote server 102 may support a website from which the requested file is downloadable. Using HTTP as an example, P1 510 from VM1 231 may include a HTTP request specifying a uniform resource locator (URL) associated with remote server 102 from which a file is downloaded, such as “www.xyz.com/file.exe.” In this case, P2 515 from remote server 102 may include a HTTP response that includes data associated with the downloadable file. In the example in FIG. 5, VM1 231 may be associated with IP address=IP-VM1, and remote server 102 associated with IP address=IP-S.

At 520 in FIG. 5, in response to detecting P1 510, guest introspection agent 155 implemented by VM1 231 may generate and send event information to MPS-A 130 associated with VM1 231. In general, the event information may include process event information and/or network event information. Example process event information associated with first process 150 may include process ID, process hash information, file name, certificate/license information, etc. The process hash information may be unique to a particular process or software application and calculated using any suitable hash algorithm, such as MD5 (i.e., message-digest), secure hash algorithm (SHA), etc. Example network event information may include 5-tuple information (SIP=IP-VM1, SPN=80, DIP=IP-S, DPN=5001, PRO=HTTP), URL1=www.xyz.com/file.exe from which a file download is initiated, etc.

For example in FIG. 5, first process 150 implemented by VM1 231 on host-A 210A is associated with (process ID=1001, process hash=ABCD). At host-B 210B, second process 160 implemented by VM2 232 is associated with (process ID=2001, process hash=ABCD). Further, third process 170 implemented by VM5 235 is associated with (process ID=3001, process hash=ABCD). Here, the process ID is unique to each process 150/160/170. Since processes 150-170 represent different instances of the same process, the process hash information=ABCD is the same. In this example, guest introspection agent 165 implemented by VM2 232 may generate and send event information (e.g., process ID=2001, process hash=ABCD, etc.) towards MPS-B 140. Similarly, guest introspection agent 175 implemented by VM5 235 may generate and send process event information (e.g., process ID=3001, process hash=ABCD, etc.) towards MPS-B 140. See 521-522 in FIG. 5.

In practice, guest introspection agent 155/165/175 may be configured to monitor events and packet flows associated with VM 231/232/235. For example, guest introspection agent 155/165/175 may register hooks (e.g., callbacks) with kernel-space or user-space module(s) implemented by a guest OS to monitor new network events, process events, etc. In response to detecting a new connection or session initiated by VM 231/232/235, guest introspection agent 155/165/175 receives a callback from associated guest OS. In practice, guest introspection agent 155/165/175 may be a guest OS driver configured to interact with packet processing operations taking place at multiple layers in a networking stack of the guest OS and intercept process and/or network events. See also 415 and 425 in FIG. 4.

(b) Malicious Network Activity Detection

At 530 in FIG. 5, EDGE 110 may determine whether there is a malicious network activity based on P1 510 from VM1 231 and/or P2 515 from remote server 102. In practice, any suitable approach for malicious network activity detection may be implemented. In one example, the content of P1 510 and/or P2 515 may be inspected to identify any malware. In another example, the detection may be based on a reputation score associated with a website/URL supported by remote server 102, such as by comparing the reputation score to a threshold. Here, the term “reputation” may refer generally to information indicating a trustworthiness associated with a source and/or data from that source. As will be discussed further using FIG. 7, malicious network activity detection may be implemented using security analyzer 740 (e.g., NSX® Security Analyzer), static analysis engine 730, cloud-based threat intelligence service(s) 760, or any combination thereof, etc.

At 540 in FIG. 5, in response to detecting a malicious network activity, EDGE 110 may generate and send an alert to central system 120. Alert packet 540 may specify any suitable information associated with the malicious network activity, including but not limited to (IP-VM1, IP-S, URL1). For example, alert packet 540 may also include source/local port number=SPN1 associated with VM1 231, destination/remote port number=DPN1 associated with remote server 102 and protocol information (e.g., TCP/UDP). Here, IP-VM1 is an IP address associated with VM1 231, IP-S is associated with remote server 102 and URL1=www.xyz.com/file.exe. Otherwise (i.e., no malicious network activity detected), EDGE 110 may allow forwarding of packet 510/515 towards its destination.

(c) First Process Termination

At 550 in FIG. 5, in response to detecting the malicious network activity based on alert 540 from EDGE 110, central system 120 may trigger termination of first process 150 implemented by VM1 231 by generating and sending a first notification (see N1) to MPS-A 130. Here, N1 550 may specify any suitable information associated with the malicious network activity, such as IP-VM1 associated with VM1 231, IP-S associated with remote server 102 and URL=www.xyz.com/file.exe, etc. Depending on the desired implementation (not shown in FIG. 5 for simplicity), N1 550 may also include source/local port number=SPN1 associated with VM1 231, destination/remote port number=DPN1 associated with remote server 102 and protocol information (e.g., TCP/UDP).

Prior to generating and sending N1 550, central system 120 may identify MPS-A 130 associated with VM1 231 based on mapping information associating a particular VM to an MPS instance. For example, at 501-503 in FIG. 5, central system 120 may store mapping information such as (IP-VM1, MPS-A), (IP-VM2, MPS-B) and (IP-VM5, MPS-B). This way, central system 120 may map (IP-VM1, IP-S, URL1) specified by alert 540 to mapping information entry (IP-VM1, MPS-A). See also 430-431, 435 and 440 in FIG. 4.

At 560 in FIG. 5, based on N1 550 from central system 120, MPS-A 130 may identify first process 150 associated with the malicious network activity. For example, based on first event information 520 received from guest introspection agent 155, MPS-A 130 may identify first process 150 by mapping (IP-VM1, IP-S, URL1) to event information specifying (process ID=1001, process hash=ABCD) associated with first process 150. See also 445 in FIG. 4.

At 570 in FIG. 5, MPS-A 130 may generate and send an instruction to VM1 231 to terminate first process 150. Depending on the desired implementation, the instruction may also instruct VM1 231 to terminate a process tree associated with first process 150. In this case, first process 150 may be a parent or child process within the process tree. Further, at 580, MPS-A 130 may send process and/or network event information associated with the malicious network activity to central system 120. See also 450 in FIG. 4.

(b) Second Process Termination

At 590 in FIG. 5, based on event information obtained from MPS-A 130, central system 120 may generate and send a second notification (N2) to MPS-B 140 to trigger termination of at least one other process that is suspected to be malicious. For example, N2 590 may be generated and sent to disseminate or spray first event information 520 associated with the malicious network activity, including (process hash=ABCD, IP-S, URL1). See also 455-460 in FIG. 4.

In the example in FIG. 5, second process 160 may be involved in a second instance of the malicious network activity by attempting to download the same malicious file from remote server 102. For example, second event information 521 associated with second process 160 may specify (process ID=2001, process hash=ABCD, SIP=IP-VM2, DIP=IP-S, URL1). Third process 170 might not have initiated a third instance of the malicious network activity at the time the event information is sprayed. In this case, third event information 522 associated with third process 170 may specify (process ID=3001, process hash=ABCD), which indicates that third process 170 (i.e., no connection with remote server 102 yet).

Since first process 150 associated with hash=ABCD is detected to be malicious, there is a likelihood that second process 160 and third process 170 with the same hash value are malicious. Based on N2 590, MPS-B 140 may map (process hash=ABCD, IP-S, URL1) to second event information 521 associated with second process 160, and third event information 522 associated with third process 170. This way, at 591-594, MPS-B 140 may instruct VM2 232 to terminate second process 160, and VM5 235 to terminate third process 170. Depending on the desired implementation, target VM 232/235 may be instructed to terminate a process tree in which potential malicious process 160/170 is a child or parent node. See also 465-470 in FIG. 4.

Using examples of the present disclosure, the detection of a first instance of a malicious network activity may be leveraged to terminate multiple processes, include first process 150 that is involved in the first instance of the malicious network activity, as well as second process 160 and third process 170. This way, second process 160 may be blocked initiating or continuing with a second instance of the malicious network activity (i.e., file download from URL1). Although third process 170 has not initiated any file download, any potential third instance of the malicious network activity may be blocked. This way, other instance(s) of the malicious network activity may be blocked before they are detected by EDGE 110.

### Second Example: MPS-Triggered Implementation

According to examples of the present disclosure, malicious network activity detection by central system 120 may be based on an alert received from any suitable entity capable of performing the detection, such as EDGE 110 (explained using FIG. 5), MPS instance (to be explained using FIG. 6 below) or any other entity (e.g., entity in a malware protection architecture in FIG. 7). See 430-431 in FIG. 4.

Some examples relating to an MPS-triggered implementation will be described using FIG. 6, which is a schematic diagram illustrating second example 600 of malicious process termination in an SDN environment. The example in FIG. 6 may be performed to provide malware protection for east-west traffic within SDN environment 100. Note that implementation details explained using FIGS. 4-5 are also applicable here and will not be repeated in full for brevity.

(a) Event Information

At 610 in FIG. 6, guest introspection agent 155 on VM1 231 may generate and send event information associated with first process 150 to MPS-A 130. Similarly, at 611-612, guest introspection agent 165/175 may generate and send event information associated with process 160/170 to MPS-B 140. The event information may include process event information and/or network event information. Depending on the desired implementation, guest introspection agent 155/165/175 may process the event information to derive pattern(s) of malicious network activity. In practice, malware protection for east-west traffic may be performed to detect, for example, a Trojan horse that attempts to spread to other systems in the network. In this case, the event information may be associated with file copy event(s) using any suitable protocol(s), such as file transfer protocol (FTP), trivial FTP (TFTP), secure copy protocol (SCP), etc.

(b) Malicious Network Activity Detection

At 620 in FIG. 6, based on the event information associated with first process 150, MPS-A 130 may detect a first instance of a malicious network activity (e.g., file copy event) and report to central system 120. At 630, central system 120 may detect the first instance of the malicious network activity based on an alert from MPS-A 130. Alert 630 may specify event information associated with first process 150, such as (process ID=1001, process hash=ABCD) and network event information associated with the malicious file copy activity.

(c) Malicious Process Termination

At 640-660 in FIG. 6, central system 120 may trigger termination of first process 150 by generating and sending a first notification (N1) to MPS-A 130, which then instructs VM1 231 to terminate first process 150 and/or its process tree. Further, at 670, central system 120 may trigger termination of further processes by generating and sending a second notification (N2) to MPS-B 140. This way, at 680-681, MPS-B 140 may identify second process 160 based on N2 670 and instruct VM2 232 to terminate second process 160 and/or its process tree. Similarly, at 690-691, MPS-B 140 may identify third process 170 based on N2 670 and instruct VM5 235 to terminate third process 170 and/or its process tree.

Using examples of the present disclosure, further instance(s) of the malicious network activity may be blocked by leveraging the detection of a first instance of that activity. This may reduce the processing burden associated with malware detection at other entities in the SDN environment 100. In practice, if VM 231/232/235 is detected to initiate malicious network activities frequently, central system 120 and/or MPS 130/140 may quarantine VM 231/232/235 to reduce or prevent further security attacks.

### Example Architecture

Examples of the present disclosure may be implemented as part of a malware protection or anti-malware system in SDN environment 100. Some examples will be explained using FIG. 7 is a schematic diagram illustrating example architecture 700 for malware prevention in an SDN environment. Using the example in FIG. 7, MPS instance 130/140 may be deployed in the form of an SVM (see 710) supported by host 210A/210B. Central system 120 may include component(s) capable of performing functionalities provided by one or more of the following: security analyzer 740, policy manager 750, static analysis engine 730 and cloud-based threat intelligence service(s) 760.

At 710 in FIG. 7, the SVM on host 210A/210B may include security hub 711 capable of providing security protection, such as collecting event information using an event collector, sending file(s) to be scanned for malware to static analysis engine 730 (which then decides whether the file(s) need to be submitted for sandboxing), selecting process or memory block for analysis using an intrusion detection system (IDS) plugin, obtaining verdicts for known files using an Advance Signature Distribution Service (ASDS) plugin, any combination thereof, etc. In practice, one goal of ASDS is to gather verdict (and associated security attributes) for an intercepted file (identified by a unique ID or hash value) from a set of predetermined source(s) and make it available to module(s) responsible for file detection with substantially minimal latency. The availability of these attributes may determine the speed with which a security policy (e.g., block or allow) may be applied to the file in question.

Security hub 711 may interact with guest introspection agent(s) associated with VM(s) on host 210A/210B. Depending on the desired implementation, plugins may be executed in the same process as security hub 711 and capable of interacting with various components such as a database (e.g., NestDB). The database may be used as a local datastore or cache for host level configuration and plugin data. Using a plugin-based architecture, security hub 711 on SVM 710 may support any desired plugins for various functionalities.

Depending on the desired implementation, verdict information associated with a file that is intercepted by EDGE 110 (north-south traffic) or MPS instance 130/140 on host 210A/210B (east-west traffic) may have one of the following values: benign (i.e., file is good or safe), trusted or highly trusted (e.g., from highly trusted source), malicious (i.e., harmful), suspicious (i.e., potentially harmful), unknown (i.e., no verdict yet) and uninspected. Reputation information associated with a file may include name of file publisher, whether the file is signed, signing authority (if signed), reputation category (e.g., malware, suspect, trusted), malware class (e.g., trojan horse, backdoor, etc.), any combination thereof, etc.

At 720 in FIG. 7, EDGE 110 may support security hub 720 capable of providing security protection, such as sending file(s) to be scanned for malware to static analysis engine 730 (which then decides whether the file(s) need to be submitted for sandboxing), obtaining file event notification using an intrusion detection system IDS plugin (or IDPS plugin), obtaining verdicts using an ASDS plugin, etc. Security hub 720 may be implemented on EDGE 110 as a process. The IDPS engine of EDGE 110 may be leveraged for file extraction for north-south traffic.

At 730 in FIG. 7, a static analysis engine (i.e., RAPID component) may be deployed to perform static analysis as well as behavioral analysis of unknown file(s) based on requests from host 210A/210B and/or EDGE 110. Verdict(s) generated by static analysis engine 730 may be stored in any suitable database.

At 740 in FIG. 7, a security analyzer may be deployed to provide various security analysis services, such as maintaining a database of file events for east-west and north-south traffic, maintaining a database of verdicts and reputation scores for all known files, reputation fetcher service, analyzer application programming interface (API) synchronization service, event processing, ASDS service having a north-bound representational state transfer (REST) API and messaging interface to obtain verdicts, reporting/auditing service that includes system reports, etc.

At 750 in FIG. 7, a policy manager may be deployed to provide security policy configuration information to host 210A/210B and interact with the reporting service of security analyzer 740.

At 760 in FIG. 7, any suitable cloud-based threat intelligence service(s) may be implemented, such as NSX® Threat Intelligence Cloud (available from VMware, Inc.), Lastline® Cloud, etc. For example, a threat intelligence database (TIDB) may be maintained to store known files in association with respective signatures and reputation/verdict information. The verdict information may also be updated by a security researcher in case of incorrect analysis by an analysis engine. In practice, Lastline® Cloud may offer a range of APIs for ingesting files for analysis, serving (correlated) detection results, visualizing data and alert triage, as well as web-based user interface(s) for sandboxing reports.

### Container Implementation

Although discussed using VMs 231-235, it should be understood that malicious process termination may be performed for other virtualized computing instances, such as containers, etc. The term “container” (also known as “container instance”) is used generally to describe an application that is encapsulated with all its dependencies (e.g., binaries, libraries, etc.). For example, multiple containers may be executed as isolated processes inside VM1 231, where a different VNIC is configured for each container. Each container is “OS-less”, meaning that it does not include any OS that could weigh 10 s of Gigabytes (GB). This makes containers more lightweight, portable, efficient and suitable for delivery into an isolated OS environment. Running containers inside a VM (known as “containers-on-virtual-machine” approach) not only leverages the benefits of container technologies but also that of virtualization technologies.

### Computer System

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform processes described herein with reference to FIG. 1 to FIG. 7. For example, computer system(s) to act capable of acting as central system 120, host 210A/210B and EDGE 110 may be deployed in SDN environment 100 to perform examples of the present disclosure.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described or can be alternatively located in one or more devices different from that in the examples. The units in the examples described can be combined into one module or further divided into a plurality of sub-units.

What is claimed is:

1. A method for a computer system to perform malicious process termination, wherein the method comprises:
detecting a first instance of a malicious network activity associated with a first virtualized computing instance;
triggering termination of a first process implemented by the first virtualized computing instance, the first instance of the malicious network activity being associated with the first process;
obtaining event information associated with the first process or the first instance of the malicious network activity, or both; and
triggering termination of a second process implemented by a second virtualized computing instance based on the event information, thereby leveraging the detection of the first instance of the malicious network activity to terminate both the first process and the second process, and to block a second instance of a malicious network activity associated with the second process.

2. The method of claim 1, wherein detecting the first instance of the malicious network activity comprises:
receiving an alert specifying the first instance of the malicious network activity, wherein the alert specifies address information associated with the first virtualized computing instance.

3. The method of claim 2, wherein detecting the first instance of the malicious network activity comprises:
receiving the alert from an entity capable of detecting the first instance of the malicious network activity based on one or more packets originating from, or destined for, the first virtualized computing instance.

4. The method of claim 1, wherein triggering termination of the first process comprises:
identifying a first malware protection service (MPS) instance associated with the first virtualized computing instance; and
generating and sending a first notification to the first MPS instance to trigger termination of the first process.

5. The method of claim 1, wherein triggering termination of the second process comprises:
disseminating the event information by generating and sending a second notification to at least one second MPS instance to trigger the termination of the second process, wherein the second process is implemented by the second virtualized computing instance (a) at the time the event information is disseminated or (b) after the event information is disseminated.

6. The method of claim 5, wherein triggering termination of the second process comprises:
generating the second notification based on the event information, wherein the second notification specifies a process hash information associated with both the first process and the second process.

7. The method of claim 1, wherein obtaining the event information comprises at least one of the following:
obtaining process event information that includes one or more of the following: process identifier (ID), process hash information, file name and certificate or license information; and
obtaining network event information that includes one or more of the following: source address information, destination address information, source port number, destination port number, protocol and uniform resource locator (URL).

8. A non-transitory computer-readable storage medium that includes a set of instructions which, in response to execution by a processor of a computer system, cause the processor to perform a method of malicious process termination, wherein the method comprises:
detecting a first instance of a malicious network activity associated with a first virtualized computing instance;
triggering termination of a first process implemented by the first virtualized computing instance, the first instance of the malicious network activity being associated with the first process;
obtaining event information associated with the first process or the first instance of the malicious network activity, or both; and
triggering termination of a second process implemented by a second virtualized computing instance based on the event information, thereby leveraging the detection of the first instance of the malicious network activity to terminate both the first process and the second process, and to block a second instance of a malicious network activity associated with the second process.

9. The non-transitory computer-readable storage medium of claim 8, wherein detecting the first instance of the malicious network activity comprises:
receiving an alert specifying the first instance of the malicious network activity, wherein the alert specifies address information associated with the first virtualized computing instance.

10. The non-transitory computer-readable storage medium of claim 9, wherein detecting the first instance of the malicious network activity comprises:
receiving the alert from an entity capable of detecting the first instance of the malicious network activity based on one or more packets originating from, or destined for, the first virtualized computing instance.

11. The non-transitory computer-readable storage medium of claim 8, wherein triggering termination of the first process comprises:
identifying a first malware protection service (MPS) instance associated with the first virtualized computing instance; and
generating and sending a first notification to the first MPS instance to trigger termination of the first process.

12. The non-transitory computer-readable storage medium of claim 8, wherein triggering termination of the second process comprises:
disseminating the event information by generating and sending a second notification to at least one second MPS instance to trigger the termination of the second process, wherein the second process is implemented by the second virtualized computing instance (a) at the time the event information is disseminated or (b) after the event information is disseminated.

13. The non-transitory computer-readable storage medium of claim 12, wherein triggering termination of the second process comprises:
generating the second notification based on the event information, wherein the second notification specifies a process hash information associated with both the first process and the second process.

14. The non-transitory computer-readable storage medium of claim 8, wherein obtaining the event information comprises at least one of the following:
obtaining process event information that includes one or more of the following: process identifier (ID), process hash information, file name and certificate or license information; and
obtaining network event information that includes one or more of the following: source address information, destination address information, source port number, destination port number, protocol, and uniform resource locator (URL).

15. A computer system, comprising a malware protection engine to:
detect a first instance of a malicious network activity associated with a first virtualized computing instance;
trigger termination of a first process implemented by the first virtualized computing instance, the first instance of the malicious network activity being associated with the first process;
obtain event information associated with the first process or the first instance of the malicious network activity, or both; and
trigger termination of a second process implemented by a second virtualized computing instance based on the event information, thereby leveraging the detection of the first instance of the malicious network activity to terminate both the first process and the second process, and to block a second instance of a malicious network activity associated with the second process.

16. The computer system of claim 15, wherein the malware protection engine is to detect the first instance of the malicious network activity by performing the following:
receive an alert specifying the first instance of the malicious network activity, wherein the alert specifies address information associated with the first virtualized computing instance.

17. The computer system of claim 16, wherein the malware protection engine is to detect the first instance of the malicious network activity by performing the following:
receive the alert from an entity capable of detecting the first instance of the malicious network activity based on one or more packets originating from, or destined for, the first virtualized computing instance.

18. The computer system of claim 15, wherein the malware protection engine is to trigger termination of the first process by performing the following:
identify a first malware protection service (MPS) instance associated with the first virtualized computing instance; and
generate and send a first notification to the first MPS instance to trigger termination of the first process.

19. The computer system of claim 15, wherein the malware protection engine is to trigger termination of the second process by performing the following:
disseminate the event information by generating and sending a second notification to at least one second MPS instance to trigger the termination of the second process, wherein the second process is implemented by the second virtualized computing instance (a) at the time the event information is disseminated or (b) after the event information is disseminated.

20. The computer system of claim 19, wherein the malware protection engine is to trigger termination of the second process by performing the following:
generate the second notification based on the event information, wherein the second notification specifies a process hash information associated with both the first process and the second process.

21. The computer system of claim 15, wherein the malware protection engine is to obtain the event information by performing the following at least one of the following:
obtain process event information that includes one or more of the following: process identifier (ID), process hash information, file name and certificate or license information; and
obtain network event information that includes one or more of the following: source address information, destination address information, source port number, destination port number, protocol, and uniform resource locator (URL).
